(19) United States
(12) Patent Application Publication
(10) Pub. No.: US 2014/0229268 A1
(43) Pub. Date: Aug. 14, 2014

(54) COMPREHENSIVE MEASUREMENT OF THE OPPORTUNITY TO SEE ONLINE ADVERTISEMENTS

(71) Applicant: VINDICO LLC, Irvine, CA (US)

(72) Inventors: Christophe L. Clapp, Corona, CA (US); Brian C. DeFrancesco, Trabuco Canyon, CA (US)

(73) Assignee: VINDICO LLC, Irvine, CA (US)

(21) Appl. No.: 14/177,500

(22) Filed: Feb. 11, 2014

Related U.S. Application Data
(60) Provisional application No. 61/763,226, filed on Feb. 11, 2013.

(51) Int. Cl. G06Q 30/02

(52) U.S. Cl. CPC G06Q 30/0242
USPC 705/14.41

(57) ABSTRACT

A method, apparatus, system, article of manufacture and computer program product provide the ability to determine the opportunity to see an online advertisement. Determinations are made regarding whether the advertisement is in a visible portion of a webpage, whether the advertisement is in an active tab of a web browser, and whether a browser window is visible. A confirmation is conducted that the visibility of the advertisement is not hindered by an element or a parent element property. A percentage of the advertisement that has an opportunity to be seen is calculated by dynamically inserting visibility trackers into the advertisement and detecting which of the trackers are concurrently visible at a same time. Times each of the trackers are visible are calculated to determine a time in view measurement by ad percentage. A determination is made whether the advertisement is shown to a real, human, non-automated website visitor.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/763,226, filed on Feb. 11, 2013, by Christophe L. Clapp and Brian C. DeFrancesco, entitled “Comprehensive Measurement of the Opportunity to See Online Advertisements (“Viewability”),” attorneys' docket number 257.72-US-P1.

This application is related to the following co-pending and commonly-assigned patent application, which application is incorporated by reference herein:

U.S. patent application Ser. No. ______ filed on the same date herewith, by Christophe L. Clapp and Brian C. DeFrancesco, entitled “SYSTEM AND METHOD TO ANALYZE AND RATE ONLINE ADVERTISEMENT PLACEMENT QUALITY AND POTENTIAL VALUE,” attorneys' docket number 257.74-US-U1, which application claims priority to Provisional Application Serial No. 61/763,236, filed on Feb. 11, 2013, by Christophe L. Clapp and Brian C. DeFrancesco, entitled “System and Methodology to Analyze and Rate Online Advertisement Placement Quality and Potential Value” attorneys' docket number 257.74-US-P1.

### BACKGROUND OF THE INVENTION

1. Field of the Invention

The present invention relates generally to online advertisements, and in particular, to a method, apparatus, and article of manufacture for determining/measuring the “viewability” of online (Internet) advertisements.

2. Description of the Related Art

Online (Internet) advertisements have become ubiquitous and synonymous with browsing the Internet (on both traditional desktop computers as well as mobile browsing platforms such as cellular devices, tablets, etc.) and mobile applications (“apps”). Often times, advertising is the primary revenue source for a website and/or app. Accordingly, it is desirable to measure and accurately determine where, when, how, and how long an advertisement has been displayed. Unfortunately, some websites/apps have exploited various techniques/weaknesses that enable the website/application to collect advertising revenue while minimizing or not even displaying an advertisement. Such mechanisms may include: setting various parameters such that an advertisement is not displayed; displaying an advertisement that only occupies a single pixel; displaying an advertisement on an area of a web page that is not visible (e.g., in the background or on an area of the web page that has been scrolled out of the user's view), etc. Accordingly, it is of interest to the advertisers as well as other parties to determine the “viewability” of an advertisement—i.e., whether an advertisement has the opportunity to be seen (OTS).

### SUMMARY OF THE INVENTION

Embodiments of the invention comprehensively measure viewability of online advertisements (on websites and/or apps) by combining various criteria and measurements. The criteria and measurements may include:
Ad delivered to real, human, non-automated website visitor;
Opportunity to see ad;
Browser Window is active;
   Browser Tab is active (webpage is visible);
   Ad is on visible portion of webpage;
   Element properties do not result in ad being hidden on webpage;
Percent of ad with opportunity to see; and
Duration of opportunity to see (by percentage of ad with opportunity to be seen) by total time ad is on page and time during ad animation.

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 shows the components that are included in initially determining if the ad has an opportunity to be seen in accordance with one or more embodiments of the invention;

FIG. 4 illustrates popular computer screen resolution statistics in accordance with one or more embodiments of the invention;

FIG. 5 illustrates one technique that may be used to measure/calculate the percentage of an ad that has an opportunity to be seen in accordance with one or more embodiments of the invention; and

FIG. 6 illustrates the logical flow for determining the opportunity to see an online advertisement in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

Embodiments of the invention provide a methodology to comprehensively measure the “viewability” of online (Internet) advertisements. Comprehensive viewability measurement is obtained using a unique methodology that combines data relating to an advertisement having an opportunity to be seen by an active, real, human, non-automated website/app visitor, the percent of the advertisement having an opportunity to be seen, and the duration of time the advertisement has the opportunity to be seen.

### DEFINITIONS

Ad Impression (Impression)

An ad impression (or advertisement impression), sometimes called a view or an ad view, is a term that refers to the point in which an ad is viewed once by a visitor, or displayed once on a web page/app.

Same Origin Policy (SOP)

In computing, the same origin policy is an important security concept for a number of browser-side programming languages, such as JavaScript™. The policy permits scripts running on pages originating from the same site (a combination of scheme, hostname, and port number) to access each other's methods and properties with no specific restrictions, but prevents access to most methods and properties across pages on different sites.

IFrame

IFrames are independent HTML documents within a webpage that limit access between the frame content and the page loading the frame. While IFrames are important for protecting private user data and scaling websites, they can put up a virtual ‘firewall’ from page level access when they are not from the same origin as the webpage.

Cross Domain IFrame

A cross domain inline frame (iframe) is a type of web technology that can be used to embed a small portion of one website within a larger “parent” page hosted on a different domain. An iframe containing content from an external site, such as a social networking or video sharing service, can easily be placed on a webpage to add new features or boost interactivity.

Nested IFrame

When one or more IFrames are contained inside another IFrame, this is referred to as a nested IFrame. In online advertising, as multiple intermediaries using IFrames for ad delivery enter the ad delivery process, IFrames collect in deeper and deeper nests, causing transparency and complexity in knowing where and how an ad is ultimately displayed because of limited webpage access due to the same origin policy. This makes it particularly challenging for advertisers as they are positioned at the end of the delivery process.

Browser

Short for web browser, a software application used to locate, retrieve and also display content on the World Wide Web, including webpages, images, video and other files. As a client/server model, the browser is the client run on a computer that contacts the Web server and requests information. The web server sends the information back to the web browser which displays the results on the computer or other Internet-enabled device that supports a browser. Popular examples include: Mozilla's Firefox™, Microsoft's Internet Explorer™, Google's Chrome™, and Apple's Safari™.

Browser Window

A window is an area on the screen that displays information for a specific program. This often includes the user interface graphical user interface (GUI) as well as the program content. Windows are used by most applications as well as the operating system itself. A typical window includes a title bar along the top that describes the contents of the window, followed by a toolbar that contains user interface buttons. Most of the window's remaining area is used to display the content.

The top of a typical Web browser window contains a title bar that displays the title of the current page. Below the title is a toolbar with back and forward buttons, an address field, bookmarks, and other navigation buttons. Below the toolbar is the content of the current Web page. The bottom of the window may contain a status bar that displays the page loading status.

(Browser) Tab

In the area of graphical user interfaces (GUI), a tabbed document interface (TDI) or a Tab is one that allows multiple documents to be contained within a single window, using tabs as a navigational widget for switching between sets of documents. It is an interface style most commonly associated with web browsers, web applications, text editors, and preference panes.

Viewport

A framed area on a display screen for viewing information. A viewport is a region of the screen used to display a portion of the total image to be shown. With respect to web browsers, the viewport is the visible portion of the canvas.

Browser Plugins

In computing, a plug-in (or plugin) is a set of software components that adds specific abilities to a larger software application. If supported, plugins enable customizing the functionality of an application. For example, plugins are commonly used in web browsers to play video, scan for viruses, and display new file types. Well-known plugins examples include Adobe Flash Player™, QuickTime™, and Java Applets™.

App

An “app” is application software that causes a computer to perform useful tasks. A mobile app is software designed to run on smartphones, tablet computers, and other mobile devices. As used herein, an app refers to both mobile and non-mobile based apps.

Adobe Flash Player™ Application

The Adobe Flash Player™ application is freeware software for viewing multimedia, executing Rich Internet Applications, and streaming video and audio, content created on the Adobe Flash™ platform. The Flash Player™ application can run from a web browser (as a browser plug-in) or on supported mobile devices. The Flash Player™ application runs SWF (small web format) files that can be created by the Adobe Flash Professional™ authoring tool, by Adobe Flex™ or by a number of other Macromedia™ and third party tools.

Html5

HTML (HyperText Markup Language) Version 5 “HTML5” is the latest generation of HTML from the Web Hypertext Application Technology Working Group (WHATWG)™ of the World Wide Web Consortium (W3C). HTML5 was designed to provide a comprehensive application development platform for Web pages that eliminates the need to install third-party browser plug-ins such as Java™ and Flash™. HTML5 provides support for 2D (two dimensional) graphics (see canvas element), document editing, drag and drop, browser history management, audio and video playback, local file storage, among other features and enhancements. The first draft of HTML5 was released from the W3C in early 2008, while the final standard is expected in 2014. Up-to-date Web browsers support most of the published features of HTML5, as well as most Web pages written in previous versions of HTML.

Cascading Style Sheets (CSS)

Cascading Style Sheets (CSS) is a style sheet language used for describing the presentation semantics (the look and formatting) of a document written in a markup language. Its most common application is to style web pages written in HTML and XHTML (extensible HTML), but the language can also be applied to any kind of XML (extensible markup language) document, including plain XML, SVG (scalable vector graphics) and XUL (SML User Interface Language).

Document Object Model (DOM)

The Document Object Model (DOM) is a cross-platform and language-independent convention for representing and interacting with objects in HTML, XHTML and XML documents. The Document Object Model allows for programs and scripts to dynamically access and update the content, structure and style of documents.

Hardware Environment

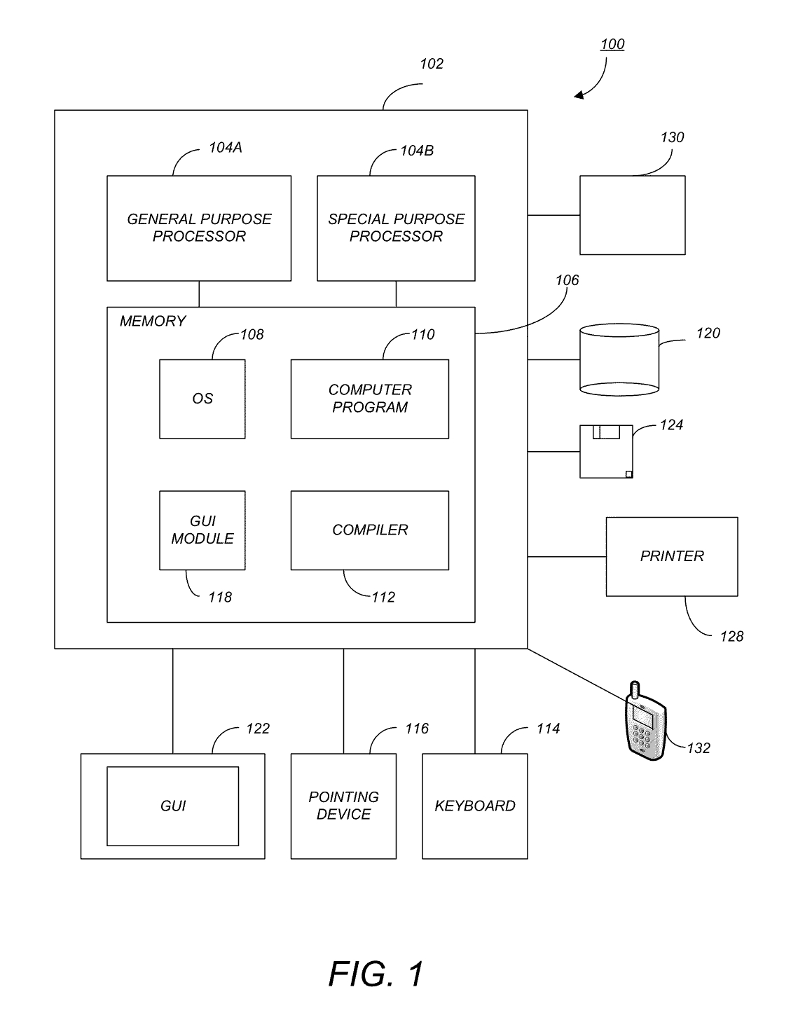

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. Alternatively, computer program 110 may be an app or mobile app that is retrieved via a network and installed on the computer 100. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

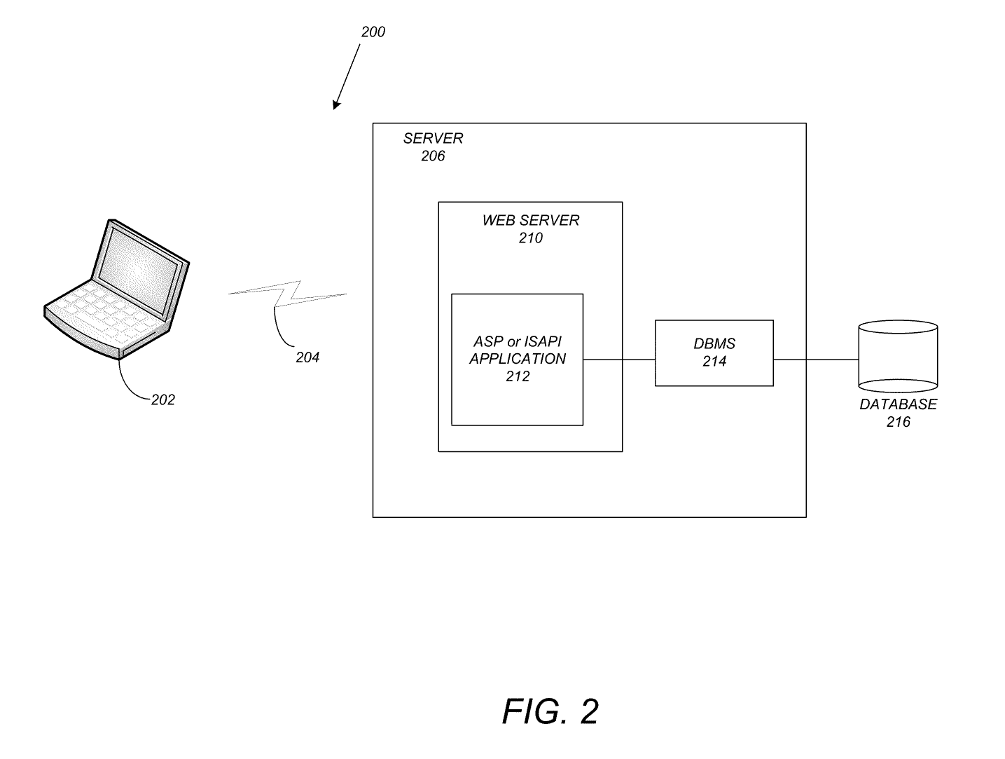

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application, app, mobile app, or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser or as an app/mobile app. Accordingly, clients 202 may utilize ACTIVEX™ components/component object model (COM) or distributed COM (DCOM) components to provide a user interface on a display of client 202. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT′S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

Software Embodiment Overview

Embodiments of the invention are implemented as a software application on a client 202 or server computer 206. Further, as described above, the client 202 or server computer 206 may comprise a thin client device or a portable device that has a multi-touch-based display.

The unique methodology for this invention relates to identifying when an online advertisement has an opportunity to be partially or fully seen, identify if the user on the webpage where the ad is delivering is a real, human, active, non-automated webpage visitor, and combining this data with measurements of time, ad area, and ad animation or video play duration to create a comprehensive measurement of online ad viewability. The methodology is applicable to both online display “banner” ads (rich media formats or images), video ads, and any other visual paid content, media branding or advertisement based initiatives.

Opportunity to See (“OTS”)

Identifying when an ad has an opportunity to be seen is based on a number of conditions being satisfied. These conditions include dimension and state (on/off, active/inactive, etc) properties of the following: computer monitor/screen, browser window, browser tabs, webpage visible area displayed within the tab, and the ad being on the visible or non-visible portion of the webpage.

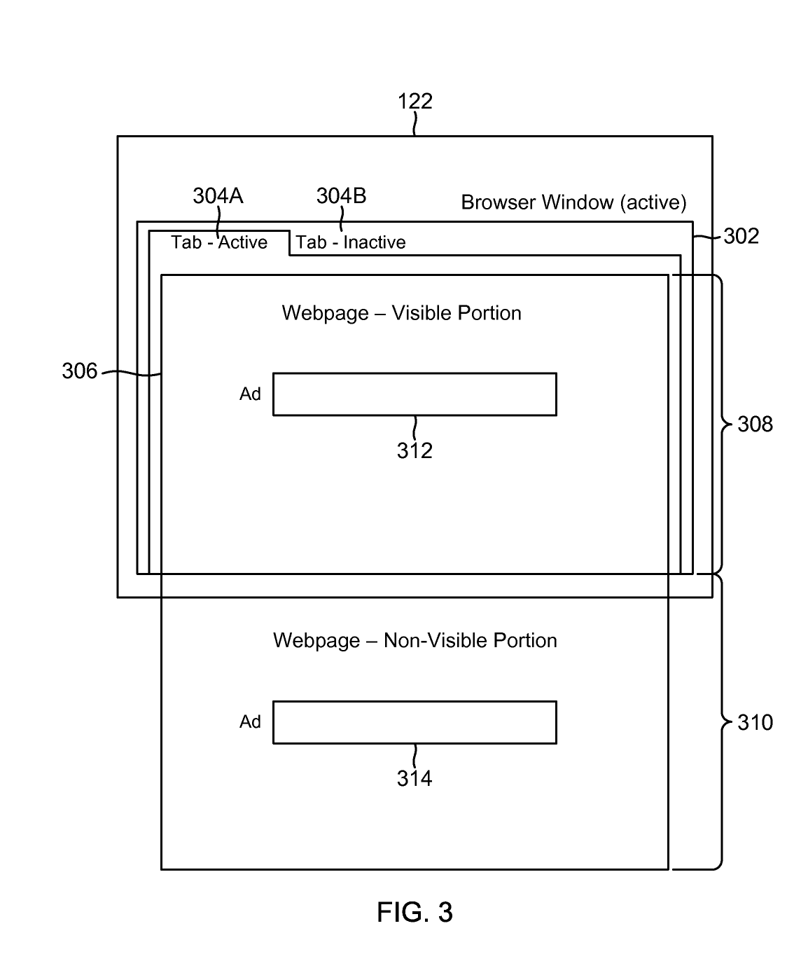

FIG. 3 shows the components that are included in initially determining if the ad has an opportunity to be seen. Display 122 (e.g., a computer monitor/screen) is configured to display an active browser window 302 (e.g., a GUI). Within the active browser window 302, there may be multiple tabs 304, including an active tab 304A and an inactive tab 304B. Within the active tab 304A, a webpage 306 is displayed. The webpage 306 has a visible portion 308 and a non-visible portion 310. As illustrated, ad 312 is in the visible portion 308 of the webpage 306, while ad 314 is in the non-visible portion 310 of the webpage 306. Similar features and components may exist with respect to an app/mobile app.

Visible Portion 308 of Webpage 306 or App

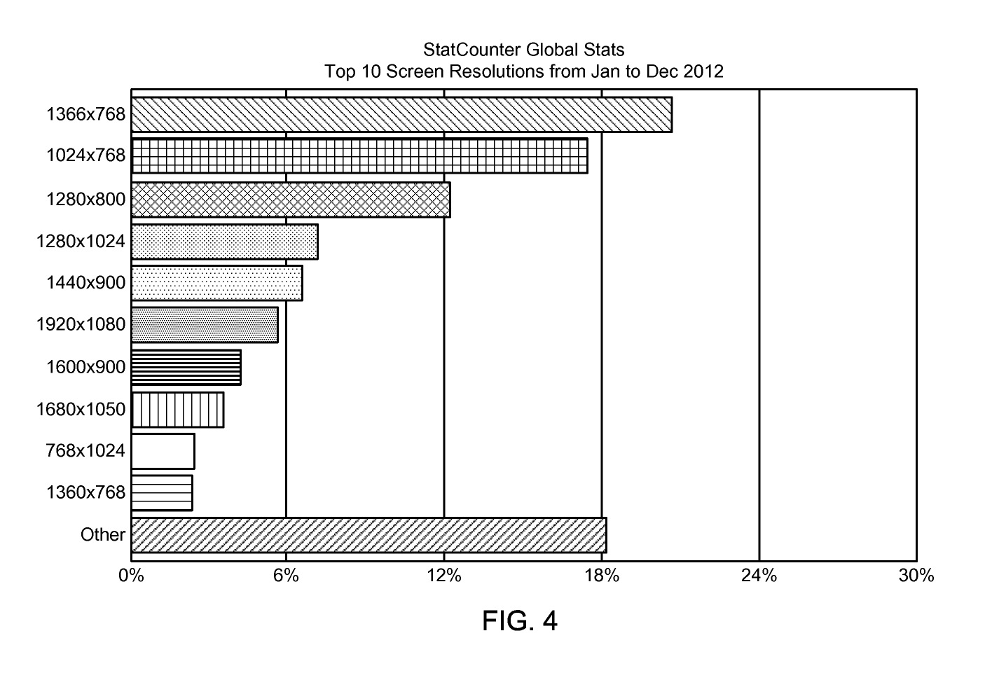

Webpages 306 vary in length. The average webpage 306 is over 4600 pixels in height. The most popular computer screen resolution is 768 pixels in height as denoted in the global browser statistics chart illustrated in FIG. 4.

When the webpage 306 (or app) height is larger than the screen 122 height (or screen of a mobile device), webpage visitors must scroll the page up or down to view content not in their viewport. Therefore, one approach to detecting if an ad 312/314 on the webpage 306/app is in the viewport is to use a geometrical measurement. Geometric measurement is primarily based on measuring an ad's position on a webpage 306 and the webpage's position in the browser 302 (with respect to page scroll position, browser size, viewport). The problem is that this data is not always obtainable. IFrames are often used in ad delivery by publishers, ad servers, ad networks, or other intermediaries. Due to the Same Origin Policy, these IFrames often limit or block the ad from accessing information on the webpage 306 including position and data needed for a geometrical measurement to be reliable and accurate on nearly all ad impressions.

An alternative to geometric measurement is to identify and track resource performance optimizations that take place when webpage objects view state changes.

Browser Plugin View State Performance Optimizations

Flash™ player is installed on over 95% of all personal computers. 94% are using Flash™ player versions 10 or greater.

Starting with Adobe Flash Player 10.1™, Adobe™ has added features that help save CPU (central processing unit) processing. These features involve pausing (or throttling) and resuming SWF content when a flash object on a webpage 306 goes outside of the visible area 308 of a webpage 306.

Two scenarios cause the SWF content to be considered outside of the visible areas 308 of a webpage 306:
1) The user scrolls the page and causes the SWF content to move outside of the visible areas of a webpage.
2) Another tab is opened in the browser, which causes the SWF content to move to the background.

When these scenarios occur, to save processing, the SWF content is slowed down, or throttled (referred to as a ThrottleEvent™), to between 2 and 8 frames per second until the SWF content becomes visible again. For Flash Player 11.2™ and later running on Windows™ and Mac™ desktop browsers, in addition to the frames per second decrease, a ThrottleEvent™ is dispatched when the content goes in and out of view.

Without knowing the position of the ad on the page and the page's position in the viewport (geometric approach), this approach will accomplish the same outcome which is to determine if the ad is in the visible portion of the webpage.

The benefit over a geometric measurement is that this does not rely on being able to access the webpage (not be inside restricting IFrames) making this approach affective at measuring if an ad is on the visible portion of the webpage on the overwhelming majority of all ad impressions.

Browser Based View State Performance Optimizations

Alternatives and additions to browser plugins such as Flash Player™ that have view state processing optimization events include the browsers' own view state optimizations such as “requestAnimationFrame” which was introduced in HTML5.

Similar to Flash Player™, the browser can throttle the frame-rate or pause the play of animated objects based on the object being in or out of view and on an active window or tab.

The requestAnimationFrame API (application programming interface) gives web developers a means to create power efficient and smooth animations. This API will take page visibility and the display's refresh rate into account to determine how many frames per second to allocate to the animation.

By leveraging requestAnimationFrame on an object, only animations that are visible run at a higher frame-rate. As soon as the animation is detected not to be in view, the animation is halted or throttled down to a lower frames per seconds, but automatically resumed after becoming active again.

requestAnimationFrame is supported on the various browser versions such as Chrome™ (versions 21 and higher), Firefox™ (version 14 and higher), Safari™ (version 6 and higher), and Internet Explorer™ (version 10 and higher) which covers the vast majority of all web browsing on PCs and mobile devices.

Embodiments of the invention use both browser plugin based view state performance optimization detection and browser based performance optimization detection independently and together based on what is technically needed due to the browser, operating system, browser plugins, and ad delivery environment to determine if, when, how much, and for how long an ad appears on the visible portion of the webpage.

Browser Tab

Most popular modern browsers 302 supported tabbed browsing. Tabs 304 were implemented in Web browsers 302 to effectively contain multiple pages or documents in a single window. Each item occupies the browser's entire viewing area when displayed. Tabs 304 facilitate navigation among the items. In general, a maximum of one tab 304 per window can be active and open for full viewing by a user.

In accurately determining if an ad has an opportunity to be seen, the state of the browse tab (active 304A or inactive 304B) is a critical component to combine with knowing if the ad is in the visible portion 308 of the webpage.

The tab's state (active 304A or inactive 304B) is often obtainable by the same events that used to detect if an object on the webpage is on the visible portion 308 of the webpage (browser or browser plugin view state based performance optimization events). In browsers 302 where this is not the case and/or to ensure the accuracy of this detection, there are additional methods for obtaining the tab's state (active 304A or inactive 304B). Embodiments of the invention may use the Page Visibility API to obtain the state (active 304A or inactive 304B) of the browser tab displaying the webpage 306 displaying the ad 312/314 and monitoring the state for changes while the ad 312/314 is displayed.

The Page Visibility API enables access to the browser 302 to know when a webpage 306 is visible 308 or in focus. With tabbed browsing, there is a reasonable chance that any given webpage 306 is in the background and thus not visible 310 to the user. When the user minimizes the webpage 306 or moves to another tab 304, the API sends a “visibilitychange” event regarding the visibility of the page 306. This event is detectable and can be used to perform some actions when triggered.

The Page Visibility API is supported in various versions of the majority of browsers including Chrome™ (versions 13 and higher), Firefox™ (versions 10 and higher), Internet Explorer™ (versions 10 and higher), and Opera™ (versions 12.10 and higher).

Browser Window

In accurately determining if an ad has an opportunity to be seen, the state of the browser window 302 is another component to combine with knowing if the ad is in the visible portion 308 of the webpage 306 and the state of the browser tab 304 that is displaying the webpage 306 that is displaying the ad 312/314.

Browser windows 302, like most application windows, can be fully visible, partially visible, or hidden. Embodiments of the invention display a visible window on the screen. If a window is visible 308, the user can supply input to the window and view the window's output. There are various window states:
Maximized Window: By default, the system enlarges a maximized window so that it fills the screen or, in the case of a child window, the parent window's client area.
Minimized Window: By default, the system reduces a minimized window to the size of its taskbar button and moves the minimized window to the taskbar.
Restored Window: A restored window is a window that has been returned to its previous size and position, that is, the size it was before it was minimized or maximized.

The browser window state is often obtainable by the same events that embodiments of the invention use to detect if an object on the webpage 306 is on the visible portion 308 of the webpage 306 (browser or browser plugin view state based performance optimization events). In circumstances where the browser 302 and/or operating system do not currently support or enable this detection through any of the methods described above and/or to improve the accuracy of window state detection, embodiments of the invention include the use of additional browser window properties, including but not limited to:
onpageshow which is an event attribute in HTML5. The code in the attribute is called when the window becomes visible.
onblur and onfocus attributes on window (window.onblur and window.onfocus). The onfocus attribute fires the moment that the element gets focus. The onblur attribute fires the moment that the element loses focus.

Ad and Parent Element Properties

Another component of embodiments of the invention determining if an ad has an opportunity to be seen is to analyze the element properties which include height, width, CSS styles, inherited CSS styles, and other properties of the ad DOM element and parent DOM elements of the ad 312/314.

Even though ad elements can be on the visible portion 308 of a webpage 306 and on an active tab 304A in an active window 302, there are situations (whether fraudulent or accidental) where the ad 312/314 is not visible to a webpage visitor because of the ad DOM elements size, styles, or the size and styles of any ad DOM parent elements. For example if an ad is placed inside an element such as an iframe with height and width of 0 or 1 pixels, the ad is not perceivably visible to a user even if it is located on the visible portion of a webpage 306. A common technique to hide ads (on accident or purposefully so websites can receive additional ad revenue) include hiding ads by setting CSS styles such as “display:none”, “visibility:hidden”, and/or opacity to 0. Through JavaScript that executes and collects data on the ad element and all ad parent element properties, embodiments of the invention confirm that the ad's visibility is not hindered by an element or parent element properties. The properties collected and analyzed include:
Element Type
Visibility
Display
Height
Width
Offset Position
Z-Index
Position
Overflow
Opacity

Browser Window, Browser Tab, Visible or Invisible Portion of Webpage, Element Properties

In embodiments of the invention, the opportunity for an ad 312/314 to be seen is determined by combining multiple data points and conditions. All criteria must pass their applicable checks before an ad 312/314 is considered to have any opportunity to be seen. Therefore, even if the ad 312/314 is in the visible area 308 of a webpage 306, but the browser tab 304 or browser window 302 is not active, the ad 312/314 cannot be considered as having an opportunity to be seen. Likewise, if the browser window 302 and browser tab 304 are active, but the ad 312/314 is not in the visible portion 308 of the webpage 306 (i.e., in portion 310), the ad 314 cannot be considered as having an opportunity to be seen. Only when all of these conditions are met, an ad 312/314 has an opportunity to be seen. The percent of the ad 312/314 that had an opportunity to be seen, the length of time it had an opportunity to be seen, and whether the webpage visitor is a real user are additional considerations in validating and measuring ad viewability and are detailed below.

Percent of Ad with “OTS”

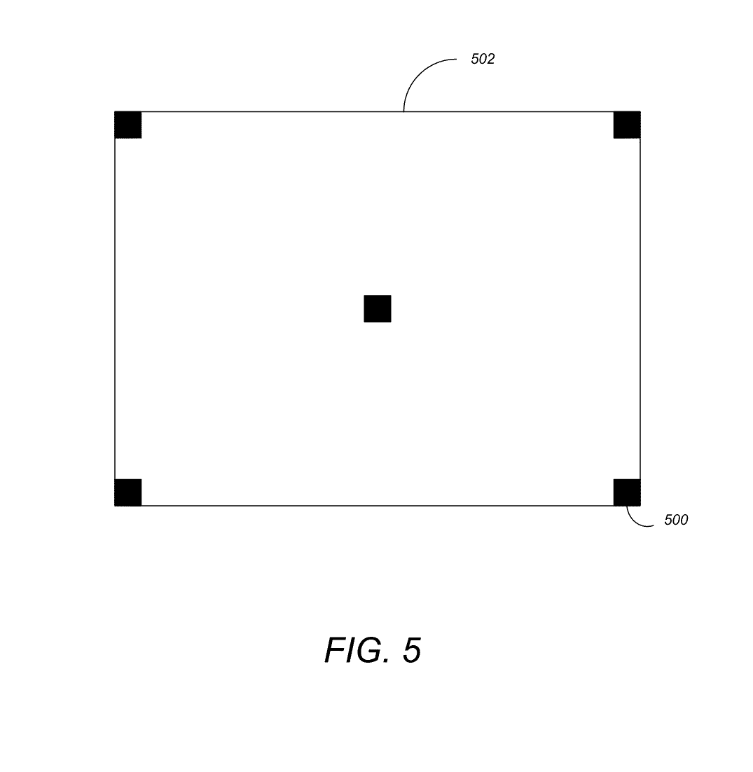

In addition to detecting an ad has an opportunity to be seen, embodiments of the invention measure viewability by also calculating the percentage of the ad that had an opportunity to be seen. FIG. 5 illustrates one technique that may be used to measure/calculate the percentage of an ad that has an opportunity to be seen. Five visibility tracking DOM elements (i.e., visibility trackers 500) are inserted in the four corners and center of an advertisement 502. It may be noted that in FIG. 5, the visibility tracker 500 sizes are exaggerated. In practice such visibility trackers 500 may be approximately 1 pixel×1 pixel or may be set to not be noticeable when viewing the advertisement.

Using the methodology described above to determine when an element is on the visible portion 308 of a webpage 306/app, each visibility tracker 500 detects when it is on and off of the visible portion 308 of the webpage 306/app. The data from all visibility trackers 500 is combined to determine when 100%, 50%, and 25% of the ad 502 has an opportunity to be seen based on which trackers 500 are concurrently visible at the same time.

Duration of Ad with “OTS”

In addition to detecting an ad has an opportunity to be seen and the percentage of the ad that had an opportunity to be seen, embodiments of the invention may also calculate the duration that the ad has an opportunity to be seen by area percentage visible.

This is calculated by recording the times that the visibility trackers come into and out of view. By aggregating the data from all visibility trackers and combining the times each visibility tracker is in and out of view with the animation times of the ad, the viewability output contains time in view measurements by ad area percentage for overall time in view and time in view during ad animation. An example calculation output is shown below:
Ad Duration=30
Example Advertisement: seconds

| | | Total Time in View |
|---|---|---|
| Percent of Ad In View | Total Time In View | During Ad Animation |
| 100% | 15 s | 15 s |
| 50% | 30 s | 30 s |
| 25% | 55 s | 30 s |

### Real, Human, Non-Automated Website Visitor

For an ad to truly have an opportunity to be seen, it must actually be shown to a real, active, human, non-automated (“non-robot”) webpage/app visitor. An automated robot or an inactive user's computer do not provide an opportunity for the ad to been seen even if all other criteria are met. In order to determine if a user and/or machine meet these criteria, the following measures may be collected and analyzed:
Check for the presence/existence of a connected mouse (e.g., in JavaScript™);
Check the mouse position periodically and compare to the last check (e.g., using JavaScript™, use a setInterval( ) or similar functionality). If the mouse hasn't moved in a set amount of time, the user can be determined to be idle;
Analyze the number of impressions from the same IP Address and IP Address and User Agent within a given time period; For example, if the number of ads from a given IP address within a day deviates significantly from the median number of ads per IP for the same day, there is a greater chance that some of the traffic from the given IP address is non-human. The same analysis can be applied to the (IP address, User Agent) pair.
Analyze the number of impressions from a different User Agent with the same IP Address and/or same cookies; Sometimes, devices generating non-human traffic will try to appear more like a group of humans by frequently altering the device(s) User-Agent strings in order to appear as if it were coming from a group of different devices and browsers, rather than all from the same (browser, IP address) pair. Similarly, devices will clear cookies at fairly frequent intervals or maintain several sandboxed copies of the same cookie with different values to appear as distinct users sharing the same IP address. Therefore, by tracking the number of impressions by time period, cookie, IP address, User-Agent, and combinations of those, one can attempt to statistically identify whether the counts fall inside or outside of what would be expected from human traffic.
Cookie deletion frequency within a time period; and
Time spent on pages and average time ads are in view.

### Logical Flow

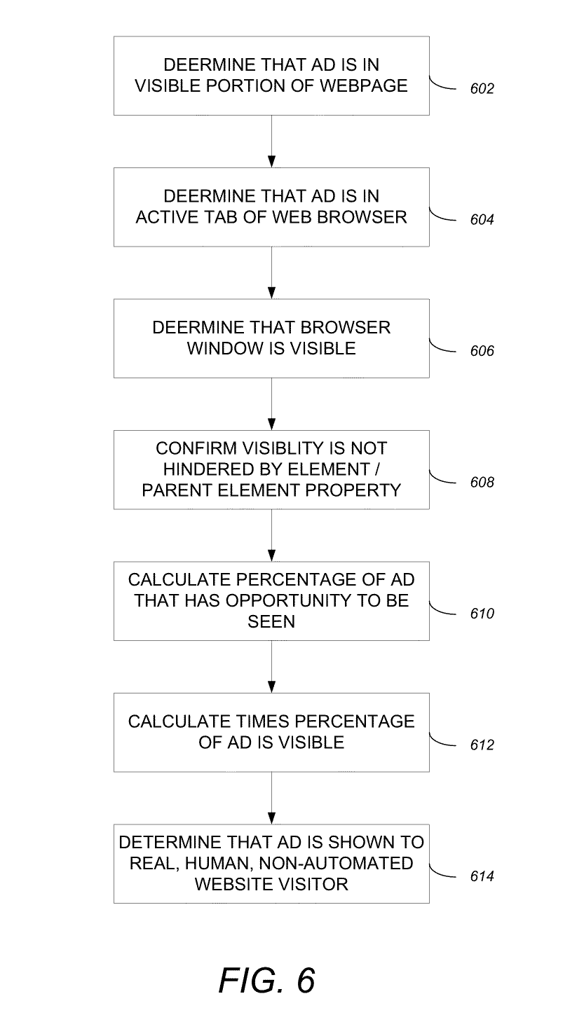

FIG. 6 illustrates the logical flow for determining the opportunity to see an online advertisement in accordance with one or more embodiments of the invention. As described above, the opportunity for an ad to be seen is determined by combining multiple data points and conditions. All criteria must pass their applicable checks before an ad is considered to have any opportunity to be seen. In addition, the percent of the ad that had the opportunity to be seen, the length of time it had an opportunity to be seen, and whether the webpage visitor is a real user are additional considerations in validating and measuring ad viewability.

At step 602, a determination is made that the online advertisement is in a visible portion of a webpage/app. Such a determination may be made by conducting a geometrical measurement by measuring the position of the ad on the web page/app and the position of the webpage in the web browser (or the app within a parent application/app). Alternatively, a plugin installed in the web browser may be used to determine that either: the user has scrolled the webpage and caused content to move outside of the visible portion of the webpage, or another tab is opened in the browser and caused content to move to the background. In yet another embodiment, an API may be used to detect whether an animation is in view, resulting in a modifying a throttling of the number of frames per second allocated to the animation (i.e., based on whether the animation is in view).

At step 604, a determination is made that the ad is in an active tab of a web browser.

At step 606, a determination is made that a browser/app window (that contains the ad), is visible. Such a determination may examine the state of the browser/app window (e.g., whether the window is a maximized window or a restored window).

At step 608, confirmation is provided that the visibility of the ad is not hindered by an element property or a parent element property. As described above, such a confirmation may analyze an element property, a visibility property, a display property, a height property, a width property, an offset property, a z-index property, a position property, an overflow property, and/or an opacity property.

At step 610, a percentage of the ad that has an opportunity to be seen is calculated. The percentage is calculated by dynamically inserting visibility trackers into the ad and detecting which of the trackers are concurrently visible at the same time. The visibility trackers may be inserted into the corners (or the intersections of the boundary of the advertisement depending on the shape of the ad [e.g., four corners for a square/rectangular ad, or three corners for a triangular ad]), and the center of the ad. The percentage of the ad that has an opportunity to be seen is calculated by detecting which of the trackers is on/off the visible portion of the webpage/app.

At step 612, the times that each of the visibility trackers are visible are calculated to determine a time in view measurement by ad percentage. Such times may be calculated by aggregating data from all of the visibility trackers, combining times (that each of the trackers are on/off the visible portion of the webpage/app) with animation times of the ads, and determining the time in view measurements by ad percentage for overall time in view and time in view during ad animation (i.e., based on the aggregating and combining).

At step 614, a determination is made that the online advertisement is shown to a real, human, non-automated website/app visitor. Such a determination may involve checking/analyzing various criteria/measures. Criteria/measures may include one or more of the following:
checking for the presence of a connected cursor control device (e.g., mouse);
checking a cursor position periodically and comparing the cursor position to a previously checked cursor position (to ensure a cursor is moved in/within a defined period of time);
analyzing a first number of impressions from a first IP address and first user within a defined time period;
analyzing a second number of impressions from a second user with the same first IP address or same cookie as the first user; This metric (and the preceding metric) can be used to identify time-based patterns that would fall outside of the expected patterns for human traffic. Human traffic from the same user or device would be expected to show a pattern with most impressions grouped within certain “peak” hours of the day or days of the week, for example. If a device or user appears to have a relatively constant number of impressions for every hour of the day, for example, its likelihood of generating non-human traffic is increased.
analyzing a cookie deletion frequency within a defined time period; and
analyzing time spent on pages and average time ads are in view.

The results of each step 602-614 may be displayed/transmitted to a user as part of each step. For example, a table showing the percentage of the ad in view, the total time in view, and total time in view during ad animation may be displayed/transmitted to a user. Similarly/alternatively, a conclusion/summary of the likelihood that an ad had an opportunity to be seen may be displayed/transmitted to a user.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for determining the opportunity to see an online advertisement, comprising:
determining that the online advertisement is in a visible portion of a webpage;
determining that the online advertisement is in an active tab of a web browser;
determining that a browser window, that contains the online advertisement, is visible;
confirming that visibility of the online advertisement is not hindered by an element property or a parent element property;
calculating a percentage of the online advertisement that has an opportunity to be seen by dynamically inserting one or more visibility trackers into the online advertisement and detecting which of the one or more visibility trackers are concurrently visible at a same time;
calculating times each of the one or more visibility trackers are visible to determine a time in view measurement by ad percentage; and
determining that the online advertisement is shown to a real, human, non-automated website visitor.

2. The computer-implemented method of claim 1, wherein the determining that the online advertisement is in the visible portion of the webpage comprises:
conducting a geometrical measurement by measuring the position of the online advertisement on the web page and the position of the webpage in the web browser.

3. The computer-implemented method of claim 1, wherein the determining that the online advertisement is in the visible portion of the webpage comprises:
utilizing a plugin installed in the web browser to determine that either:
the user has scrolled the webpage and caused content to move outside of the visible portion of the webpage; or
another tab is opened in the web browser and caused content to move to a background.

4. The computer-implemented method of claim 1, wherein the determining that the online advertisement is in the visible portion of the webpage comprises:
utilizing an application programming interface (API) to detect whether an animation is in view; and
modifying or throttling a number of frames per second allocated to the animation based on whether the animation is in view.

5. The computer-implemented method of claim 1, wherein the determining that the browser window, that contains the online advertisement, is visible comprises:
determining that a state of the browser window is a maximized window or a restored window.

6. The computer-implemented method of claim 1, wherein the confirming that visibility of the online advertisement is not hindered by the element property or the parent element property comprises analyzing:
an element type property;
a visibility property;
a display property;
a height property;
a width property
an offset property;
a z-index property;
a position property;
an overflow property; and
an opacity property.

7. The computer-implemented method of claim 1, wherein:
the one or more visibility trackers are inserted in the corners and center of the online advertisement; and
the calculating the percentage of the online advertisement that has an opportunity to be seen further comprises detecting which of the one or more visibility trackers are on and off the visible portion of the webpage.

8. The computer-implemented method of claim 1, wherein the calculating times each of the one or more visibility trackers are visible further comprises:
aggregating data from all of the one or more visibility trackers;
combining times, that each of the one or more visibility trackers are on and off the visible portion of the webpage, with animation times of the online advertisement; and
based on the aggregating and combining, determining the time in view measurements by ad percentage for overall time in view and time in view during ad animation.

9. The computer-implemented method of claim 1, wherein determining that the online advertisement is shown to a real, human, non-automated website visitor comprises:
checking for a presence of a connected cursor control device;
checking a cursor position periodically and comparing the cursor position to a previously checked cursor position to ensure a cursor is moved in a first defined period of time;
analyzing a first number of impressions from a first internet protocol (IP) address and first user within a second defined time period;
analyzing a second number of impressions from a second user with the same first IP address or same cookie as the first user;
analyzing a cookie deletion frequency within a third defined time period; and
analyzing time spent on pages and average time ads are in view.

10. An apparatus for determining the opportunity to see an online advertisement, in a computer system comprising:
(a) a computer having a memory;
(b) an application executing on the computer, wherein the application is configured to:
determine that the online advertisement is in a visible portion of a webpage;
determine that the online advertisement is in an active tab of a web browser;
determine that a browser window, that contains the online advertisement, is visible;
confirm that visibility of the online advertisement is not hindered by an element property or a parent element property;
calculate a percentage of the online advertisement that has an opportunity to be seen by dynamically inserting one or more visibility trackers into the online advertisement and detecting which of the one or more visibility trackers are concurrently visible at a same time;
calculate times each of the one or more visibility trackers are visible to determine a time in view measurement by ad percentage; and
determine that the online advertisement is shown to a real, human, non-automated website visitor.

11. The apparatus of claim 1, wherein the application is configured to determine that the online advertisement is in the visible portion of the webpage by:
conducting a geometrical measurement by measuring the position of the online advertisement on the web page and the position of the webpage in the web browser.

12. The apparatus of claim 1, wherein the application is configured to determine that the online advertisement is in the visible portion of the webpage by:
utilizing a plugin installed in the web browser to determine that either:
the user has scrolled the webpage and caused content to move outside of the visible portion of the webpage; or
another tab is opened in the web browser and caused content to move to a background.

13. The apparatus of claim 1, wherein the application is configured to determine that the online advertisement is in the visible portion of the webpage by:
utilizing an application programming interface (API) to detect whether an animation is in view; and
modifying or throttling a number of frames per second allocated to the animation based on whether the animation is in view.

14. The apparatus of claim 1, wherein the application is configured to determine that the browser window, that contains the online advertisement, is visible by:
determining that a state of the browser window is a maximized window or a restored window.

15. The apparatus of claim 1, wherein the application is configured to confirm that visibility of the online advertisement is not hindered by the element property or the parent element property by analyzing:
an element type property;
a visibility property;
a display property;
a height property;
a width property
an offset property;
a z-index property;
a position property;
an overflow property; and
an opacity property.

16. The apparatus of claim 1, wherein:
the one or more visibility trackers are inserted in the corners and center of the online advertisement; and
the application is configured to calculate the percentage of the online advertisement that has an opportunity to be seen further by detecting which of the one or more visibility trackers are on and off the visible portion of the webpage.

17. The apparatus of claim 1, wherein the application is configured to calculate times each of the one or more visibility trackers are visible further by:
aggregating data from all of the one or more visibility trackers;
combining times, that each of the one or more visibility trackers are on and off the visible portion of the webpage, with animation times of the online advertisement; and
based on the aggregating and combining, determining the time in view measurements by ad percentage for overall time in view and time in view during ad animation.

18. The apparatus of claim 1, wherein the application is configured to determine that the online advertisement is shown to a real, human, non-automated website visitor by:
checking for a presence of a connected cursor control device;
checking a cursor position periodically and comparing the cursor position to a previously checked cursor position to ensure a cursor is moved in a first defined period of time;
analyzing a first number of impressions from a first internet protocol (IP) address and first user within a second defined time period;
analyzing a second number of impressions from a second user with the same first IP address or same cookie as the first user;
analyzing a cookie deletion frequency within a third defined time period; and
analyzing time spent on pages and average time ads are in view.
